(19) United States
(12) Patent Application Publication
(10) Pub. No.: US 2006/0000421 A1
(43) Pub. Date: Jan. 5, 2006

(54) Apparatus for converting a pet containment system into a den for an animal

(76) Inventor: Susan Holtz, Stamford, CT (US)

Correspondence Address: Charles N.J. Ruggiero, Esq.;Ohlandt, Greeley, Ruggiero & Perle, L.L.P., One Landmark Square, 10th Floor, Stamford, CT, 06901-2682, US

(21) Appl. No.: 10/884,632

(22) Filed: Jul. 2, 2004

(51) Int. Cl. A01K 1/03

(52) U.S. Cl. 119/452

(57) ABSTRACT

A cover for a portable pet containment system is provided. The cover has a body portion that is formed of a first resilient material and that has a first lateral side with a first edge and a second lateral side with a second edge. The second lateral side is opposite the first lateral side. The cover also has a number of members for connecting the first lateral side to the second lateral side. The number of members secure the cover on the portable pet containment system. The first lateral side is held substantially taut against the first pet containment system side, and said second lateral side is held substantially taut against the second pet containment system side, to minimize the possibility that the cover will be disturbed when positioned on the portable pet containment system.

### BACKGROUND OF THE INVENTION

1. Field of the Invention

The present invention relates to an apparatus or device for converting a pet containment system into a den for an animal. More particularly, the present invention relates to a cover that will be held substantially taut on the lateral sides of the pet containment system to prevent removal therefrom.

2. Description of the Related Art

Insulated covers for pet containment systems are known in the art. One such cover is disclosed in U.S. Pat. No. 6,446,557 B1 to Salahor. Salahor discloses an insulated cloth cover in combination with a portable pet containment system. The insulated cloth cover has a top and a bottom with the bottom fully covering the bottom of the floor of the pet containment system. The insulated cloth cover has a right side and a left side, and a front. The front has a door flap and a hook and loop fastener connecting the door flap with the insulated cloth cover.

The insulated covers of the prior art are deficient in their operation. The insulated covers are difficult to handle and manipulate especially when securing the insulated covers to the pet containment system. For example, Salahor's insulated cloth cover necessitates the animal caregiver to lift the heavy pet containment system with one hand, then place the entire pet containment system into a front opening of the insulated cloth cover that needs to be manipulated with the other hand. Such manipulation is difficult for the elderly, handicapped, or children, especially if the pet containment system is relatively large and heavy. The caregiver will have to lift and place the pet containment system on a side, then open and slide the insulated cloth cover over the pet containment system. Upon completion, the caregiver will then have to further tip the pet containment system over to return the pet containment system to an operable position for which the animal may enter and exit the pet containment system.

By tipping the pet containment system, the caregiver may injure himself or herself, the animal, or may damage the pet containment system or the insulated cloth cover. Still further, the caregiver will have to remove any and all water bowls, food bowls, toys, blankets from the pet containment system prior to application of the insulated cloth cover. Once the insulated cloth cover is applied, the caregiver will then have to replace the items. This removal and replacement is time consuming and may be difficult for the caregiver, given that the pet containment system is usually low to the ground and has a relatively smaller interior compartment therein.

Caregivers will then often, to avoid such known problems in the art, place a blanket or covering on a top of the dog crate or dog containment system. This arrangement also is inconvenient in its operation especially with the manner the covering or cover is supported or unsupported on the pet containment system. The covering will further, if windy, blow off of the pet containment system. Even if the covering does not blow off, it may not substantially cover the pet containment system entirely causing pockets of the pet containment system to remain uncovered. This uncovered pet containment system may cause an interior of pet containment system to cool, and permit light entry into the interior of the pet containment system. This uncovered pet containment system thus may not fully protect the animal therein and cause the animal distress.

Moreover, certain types of animals, such as a dog, may become very pesky with regard to any covering, especially one that is not secured thereon in an appropriate manner.

A known problem in the art is that the covering will hang away from the first and second lateral sides of the pet containment system. This will result in the formation of a large gap between the first and second lateral sides of the pet containment system and the covering. This over hang will also prevent an opportunity for such a dog. A dog may pull of the covering, or chew or damage the covering. This will cause the covering to be replaced, and thus cause unnecessary expenses.

Accordingly, there is a need for a covering or cover that eliminates one or more of the aforementioned drawbacks and deficiencies of the prior art.

### SUMMARY OF THE INVENTION

It is an object of the present invention to provide a cover that can easily be applied and removed from a pet containment system without the need to lift the pet containment system.

It is another object of the present invention to provide a cover that has a number of connectors that secure the cover to the pet containment system.

It is still another object of the present invention to provide a cover that has a number of connectors that secure the cover to the pet containment system with some of the number of connectors being inelastic and the remainder of the number of connectors being elastic.

It is yet another object of the present invention to provide a cover that has a number of connectors that are on a bottom side of the pet containment system, and this out of view, to secure the cover to the pet containment system.

It is a further object of the present invention to provide a cover that has a first lateral side and a second lateral side that are held substantially taut to a first pet containment system lateral side and a second pet containment system lateral side, respectively, to prevent an animal from tampering with the cover.

It is a still further object of the present invention to provide a cover that has an exterior surface with an aesthetically pleasing design or pattern.

It is still a further object of the present invention to provide a cover that can be selectively applied to a pet containment system by a challenged, a handicapped or an elderly individual in an easy manner.

It is still a further object of the present invention to provide a cover made from a breathable material such as a breathable fabric.

It is still another object of the present invention to provide a cover that can be selectively applied to a pet containment system while a pet is in the pet containment system.

It is still another object of the present invention to provide a cover that can be selectively applied to a pet containment system without any disruption to a pet and/or any contents in or around the pet containment system and applied in an easy manner.

These and other objects and advantages of the present invention are achieved by an apparatus for covering a portable pet containment system according to the present invention. The portable pet containment system has a first pet containment system side and a second pet containment system side. The apparatus has a body portion formed of a first resilient material. The body portion has a first lateral side with a first edge and a second lateral side with a second edge. The second lateral side is opposite the first lateral side. The cover has a number of members that connect the first lateral side to the second lateral side. The number of members secure the cover on the portable pet containment system. The first lateral side is held against the first pet containment system side and the second lateral side is held against the second pet containment system side, to prevent the apparatus from being removed from the portable pet containment system.

### DESCRIPTION OF THE DRAWINGS

FIG. 1 is a top perspective view of a pet containment system of the prior art.

FIG. 2 is a perspective view of an apparatus for covering the pet containment system of FIG. 1.

FIG. 3 is another perspective view of the apparatus for covering the pet containment system of FIG. 2.

FIG. 4 is a bottom view of the apparatus of FIG. 2.

FIG. 5 is a close up view of the first connector and the second connector of FIG. 4.

FIG. 6 is a close up view of the third connector and the fourth connector of FIG. 4.

FIG. 7 is a front perspective view of the apparatus of FIG. 2 positioned on the pet containment system of FIG. 1.

FIG. 8 is another front perspective view of the apparatus of FIG. 7 with a pattern thereon.

### DETAILED DESCRIPTION OF THE INVENTION

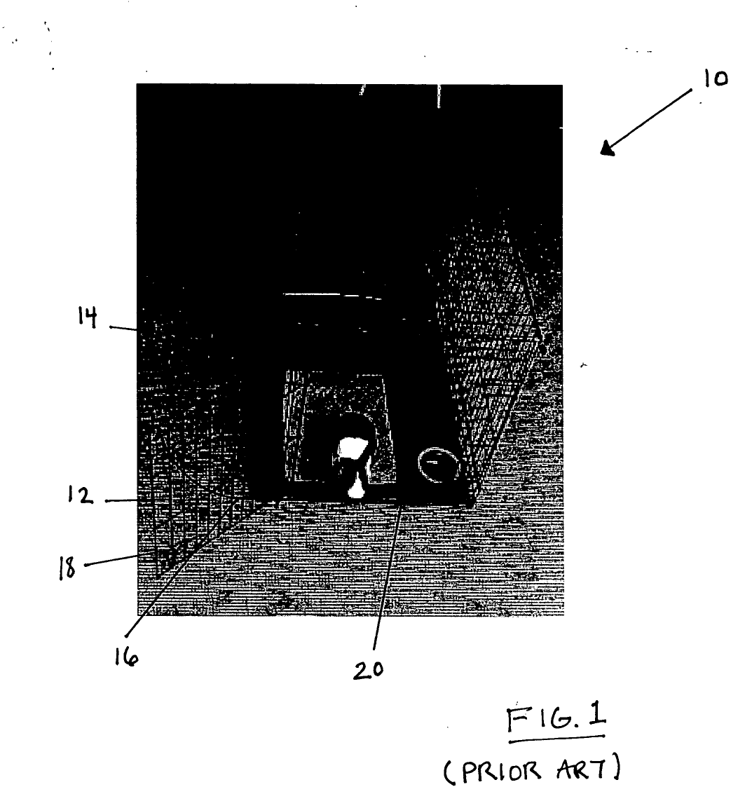

Referring to the drawings and, in particular, to FIG. 1, there is shown a pet containment system of the prior art generally represented by reference numeral 10 having an animal therein. The pet containment system 10 is preferably any structure for providing shelter to an animal. In the embodiment shown in FIG. 1, the pet containment system 10 is a crate made from a grid of resilient bars thereby having a number of interspaces. Preferably, the pet containment system 10 may also be any crate for crate training a puppy for housebreaking purposes. The number of interspaces of the pet containment system 10 allows air, light and small food particles to enter the pet containment system. The pet containment system 10 preferably has a door 12. The door 12 is preferably a hinged or movable structure that allows the door to move between an opened position and a closed position. In a preferred embodiment shown in FIG. 1, the door 12 swings between the opened position and the closed position in a direction as indicated by reference arrow 16. In this preferred embodiment, the door 12 is connected to a front of the pet containment system 10 by a suitable hinge 14. The door 12 preferably has a locking device 18 that selectively locks the door to prevent the animal from exiting the pet containment system 10 or is in an opened position, shown in FIG. 1, to allow the animal to enter the pet containment system 10.

Recently, pet professionals have advised that the care of an animal, such as a dog, should accommodate the dog's natural instinct to den. The dog has territorial instincts. One aspect of these territorial instincts is the dog's need for a den for sleeping purposes and/or resting purposes. Likewise, the caregiver will usually establish the animal's bed or mat on a floor 20 of the pet containment system 10.

Often, the pet containment system 10 is placed in a part of a house that is secluded, so the dog can have a quiet retreat when desired. Often, the pet containment system 10 is placed in the same location as the bedroom of the caregiver.

To prevent light or wind from entering the pet containment system 10, the caregiver will place a cover or blanket over the pet containment system. This arrangement is problematic. First, the cover or blanket of the prior art will not rest or be supported in a complementary fashion on the pet containment system 10. Often, the blanket and/or cover will not sit appropriately and evenly cover the pet containment system 10. Moreover, any lateral sides of the blanket and/or cover will hang off the sides of the pet containment system 10, and thus could be tampered with by the animal thereby probably damaging the cover or pulling the cover off of the pet containment system. Even though positioned on a top of the pet containment system 10, the cover may leave portions of the pet containment system exposed. This exposure will allow heat to escape from the number of interspaces of the pet containment system 10 and/or sun to enter through the number of interspaces of the pet containment system to adversely affect what is desired by the animal therein.

Second, the dog may chew and pull off the cover from the pet containment system 10 even if the blanket or cover is initially placed on the pet containment system 10 properly.

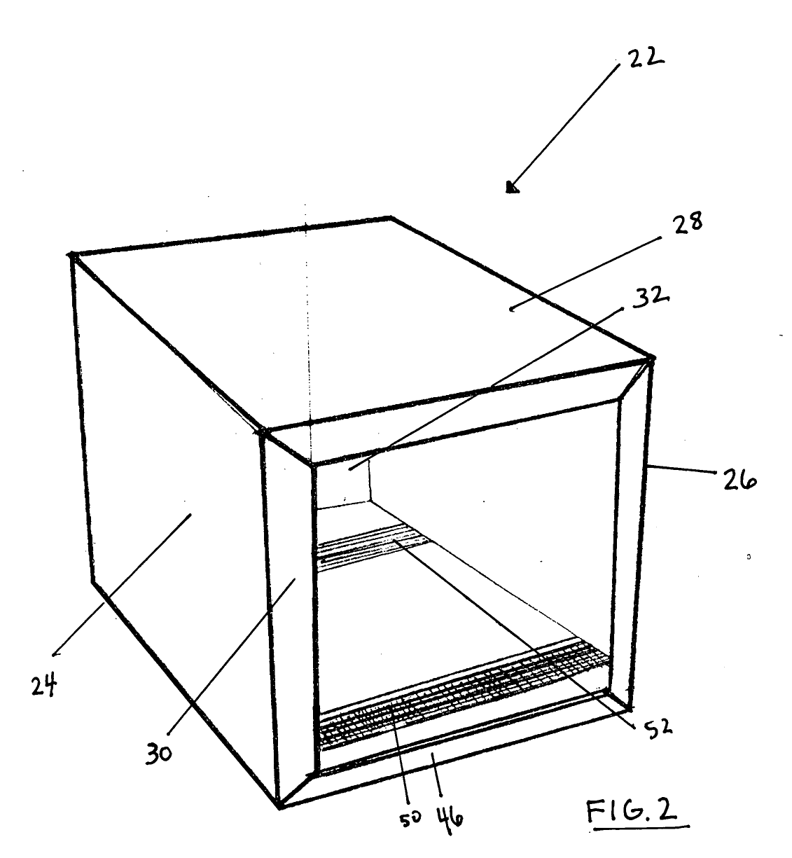

Referring to FIG. 2, an apparatus for converting the pet containment system 10 solves these problems of the prior art. The apparatus generally is referred to as a cover 22. The cover 22 is shown separated from the pet containment system 10 for illustration purposes only. The cover 22 is preferably made from a first resilient material in order to cover snuggly the pet containment system 10. The first resilient material is preferably any deformable material known in the art that will block light and also provide insulation to prevent the transfer of heat from the pet containment system 10 to ambient conditions outside of the pet containment system. Preferably, the first resilient material is a deformable material so that the cover 22 is lightweight and can be folded away in a convenient manner for storage purposes. The first resilient material most preferably is cotton weave material. Alternatively, the first resilient material may be a polyester, a bonded leather, canvas, velvet, acrylic, nylon, micro-fiber, a fleece material, a wicker material, a mesh fabric, a seagras fabric, a subrella® fabric material, a coolaroo® fabric material, leather, a velour, a silk, a nylon, a cotton, an elastomer, a weather proof material, a foam rubber, a polyvinyl chloride, a closed cell resistant foam plastic material, a polypropylene, a polyurethane, a polyethylene, a composite material, or any combinations thereof.

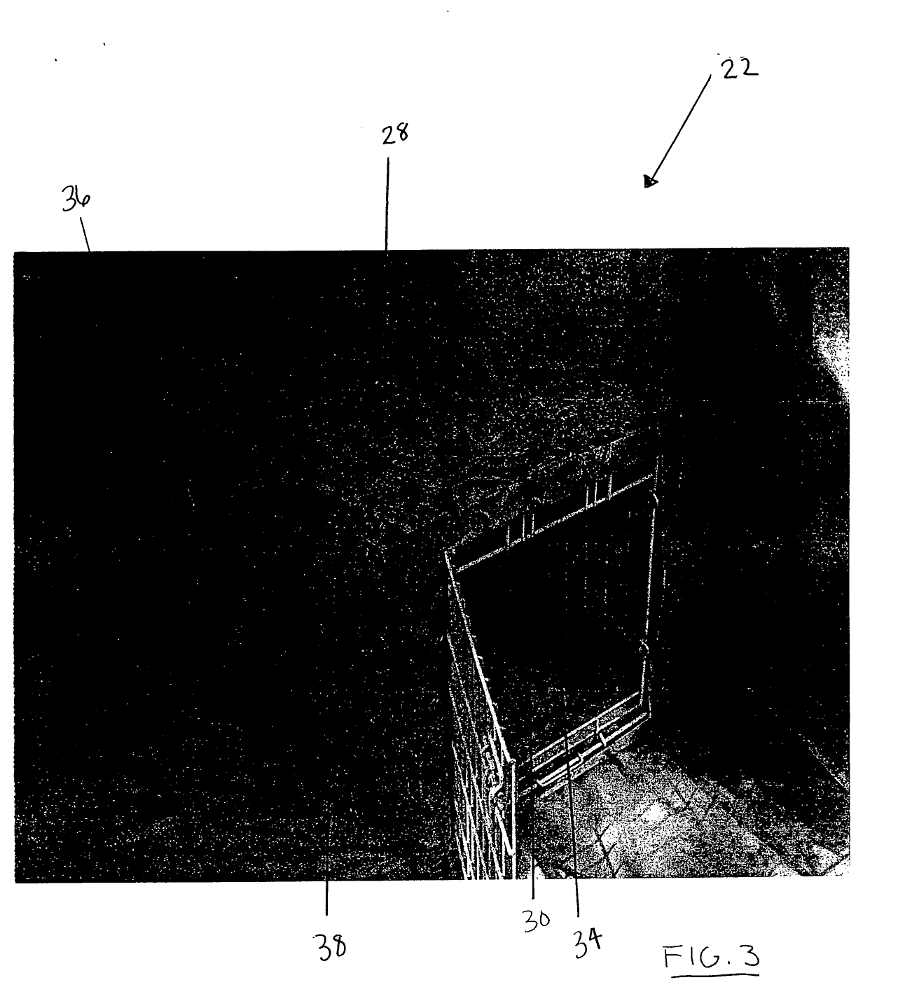

Preferably, the cover 22 has a first or lateral side 24, a second or lateral side 26, a top 28, a front 30 and a rear 32. Referring to FIG. 3, preferably, the cover 22, preferably is knit from sections of fabric material. Alternatively, the cover 22 may be formed from one unitary member or one fabric section of material. Preferably, the cover 22 has a suitable length and a width to rest snuggly over the pet containment system 10 of similar dimensions as shown in FIG. 1.

The front 30 preferably has an opening 34. The opening 34 is preferably generally orthogonal shaped and sufficiently sized to allow the door 12 of the pet containment system 10 to open and close. The rear 32 of the cover 22 may optionally have a second opening 36. One skilled in the art should appreciate that the cover 22 may be formed only with one opening 34. The second opening 36 allows a predetermined amount of light and air therethrough can allow light and/or air or be a second ingress and egress.

The cover 22 preferably is stitched together along a seam 38, and preferably made from a number of sections of fabric. Alternatively but less preferably, the cover 22 may be formed by a molding operation, an extrusion operation, a manual sewing operation, a knitting operation, a circular knitting operation or any other method known in the art.

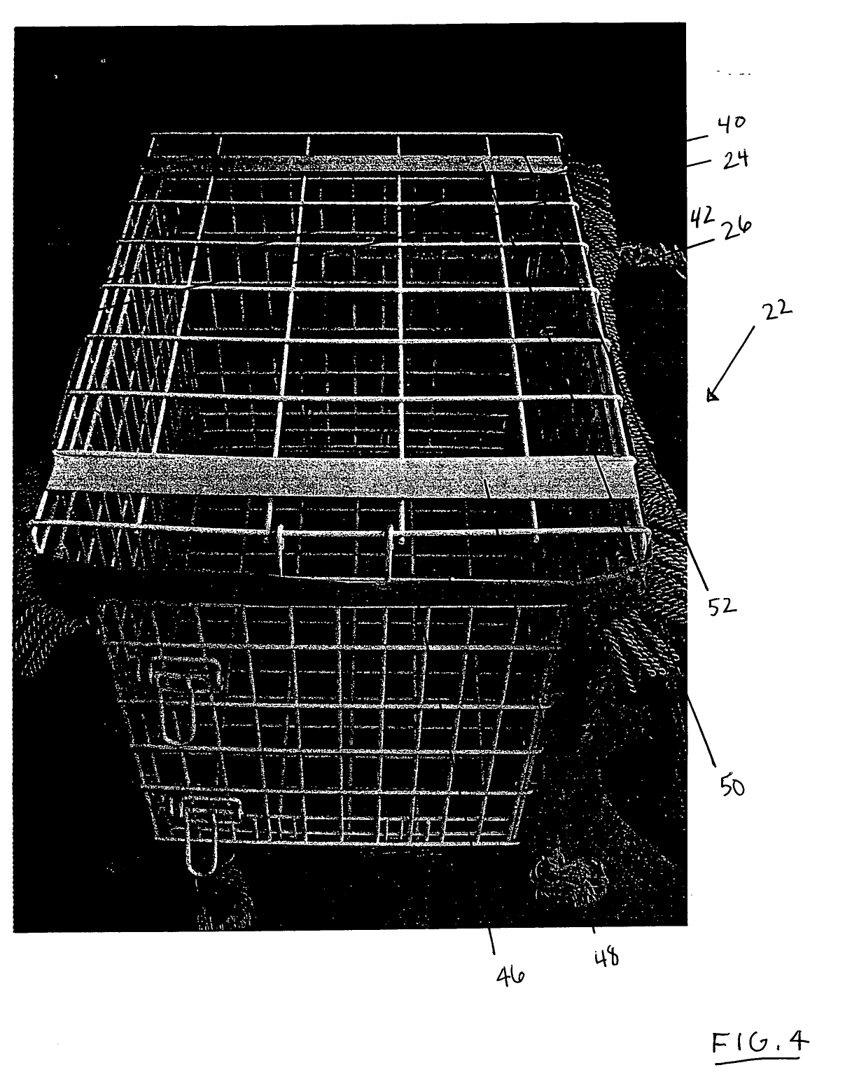

Referring to FIG. 4, there is shown a bottom view of the cover 22 for illustration purposes. The first lateral side 24 has a first edge 40 and the second lateral side 26 of the cover 22 has a second edge 42. Preferably, the first edge 40 and the second edge 42 are located at a complementary location adjacent to a bottom of the pet containment system 10 of FIG. 1 to provide a maximum amount of coverage to both the first side 24 and the second side 26 of the pet containment system as shown in FIG. 1.

The cover 22 has a number of connectors 44. Preferably, the connectors 44 connect the first edge 40 to the second edge 42. The connectors 44 preferably apply an amount of tension to impart a force on the first side 24 and the second side 26 in a direction opposite the top 30 shown in FIG. 3, when applied on the pet containment system 10. In this manner, the first side 24 and the second side 26 of the cover 22 are held taut against the first side and the second side of the pet containment system 10. Accordingly, the animal in the pet containment system 10 cannot tamper with the cover 22, or remove the cover since the cover 22 will remain supported securely in place on the pet containment system 10. Moreover, the cover 22 will be retained securely on the pet containment system 10 in an aesthetically pleasing manner. Further, the placement of the cover 22 about the pet containment system 10 will be achieved with a minimum amount of effort expended by the caregiver. This aspect is useful especially to children and the elderly.

One significant unexpected advantage of the present invention is that one skilled in the art normally would not place such connectors 44 underneath the pet containment system 10. Instead, normal clip fasteners are relatively large and bulky. This bulkiness of the known clip fasteners would prevent the pet containment system 10 from resting flush on a floor and would, in fact, disturb an orientation of the pet containment system. However, the connectors 44 of the cover 22 have an unexpected result that remedies this known problem. The connectors 44 are formed of a sufficiently thin width to permit being disposed underneath the pet containment system 10 to hide the connectors from view without any disturbance of the orientation of the pet containment system 10 so that the pet containment system is supported thereon in a sturdy manner.

Referring to FIGS. 4 through 6, in a preferred embodiment of the present invention, the cover 20 has a first connector 46, a second connector 48, a third connector 50 and a fourth connector 52. Preferably, the second connector 48 and the third connector 50 are made from an elastic material. The elastic material most preferably is an elastic band. Alternatively, the second connector 48 and the third connector 50 are a strip of stretch fabric, a hook and loop Velcro fastener, or multiple strips of fabric. Less preferably, the second connector 48 and the third connector 50 may be, a elastomeric yarn, a spandex, a visco-elastic rubber, a thermoplastic elastomer, and any combination thereof or any other elastic material known in the art.

The first connector 46 and the fourth connector 52 are preferably made from the first resilient material or the same material as the remainder of the cover 22. Alternatively, the first connector 46 and the fourth connector 52 may be formed from a cotton material, a cotton weave material, a polyester, a bonded leather, canvas, velvet, acrylic, nylon, micro-fiber, a fleece material, a wicker material, a mesh fabric, a seagras fabric, a subrella® fabric material, a coolaroo® fabric material, leather, a velour, a silk, a nylon, a cotton, an elastomer, a weather proof material, a foam rubber, a polyvinyl chloride, a closed cell resistant foam plastic material, a polypropylene, a polyurethane, a polyethylene, a composite material, or any combinations thereof.

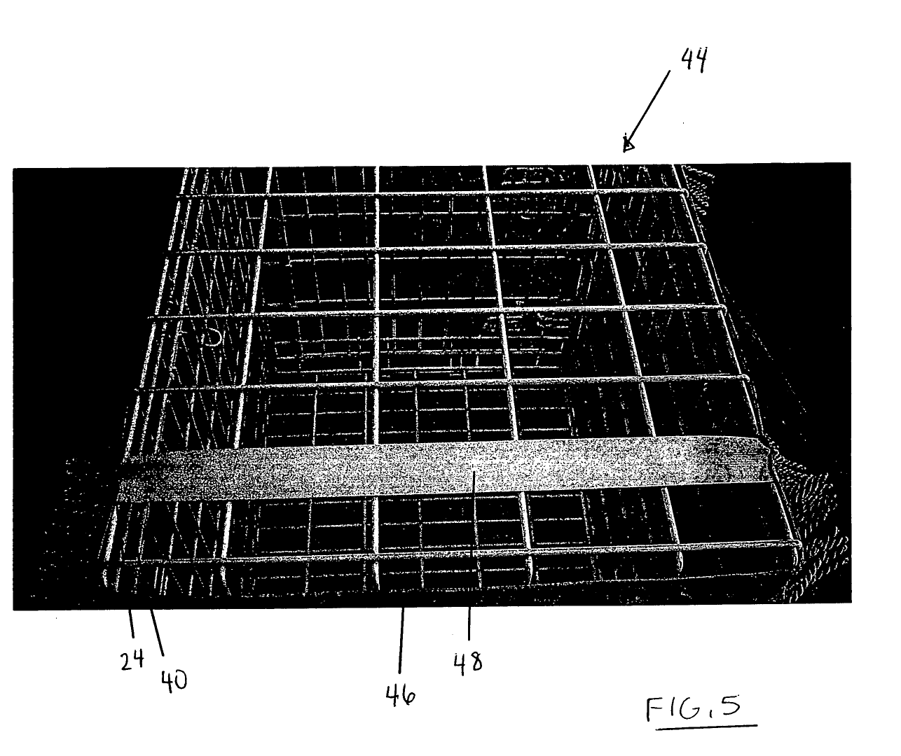

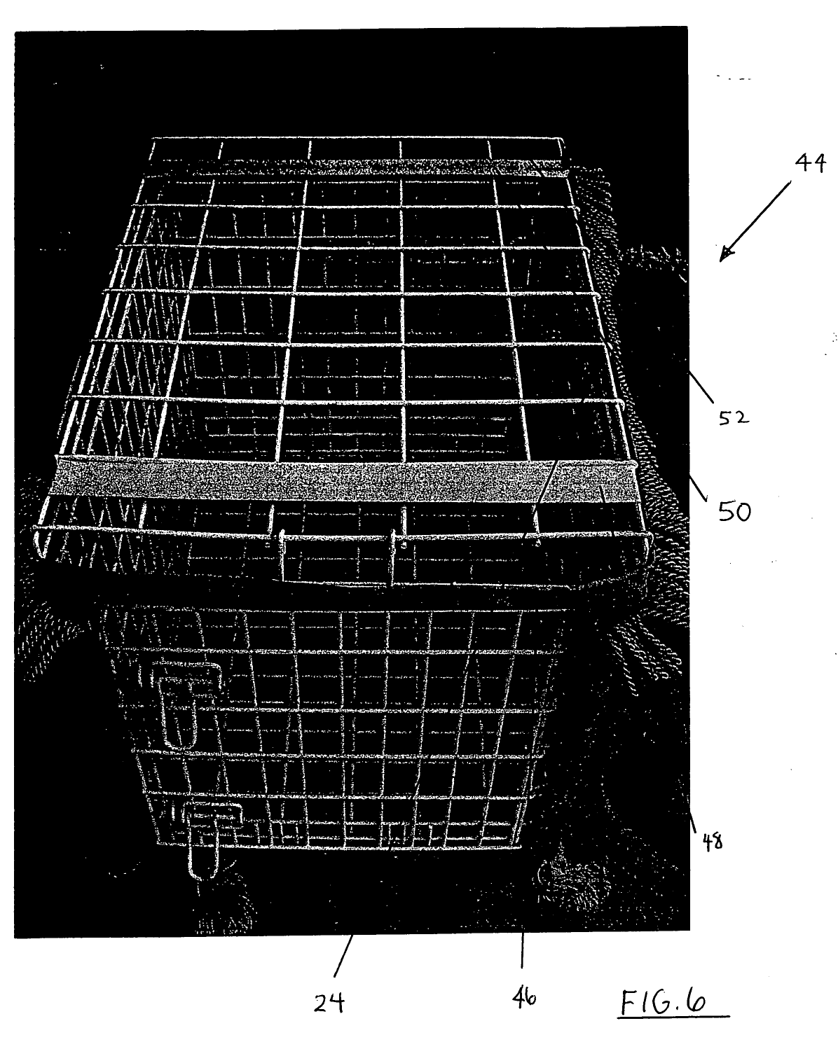

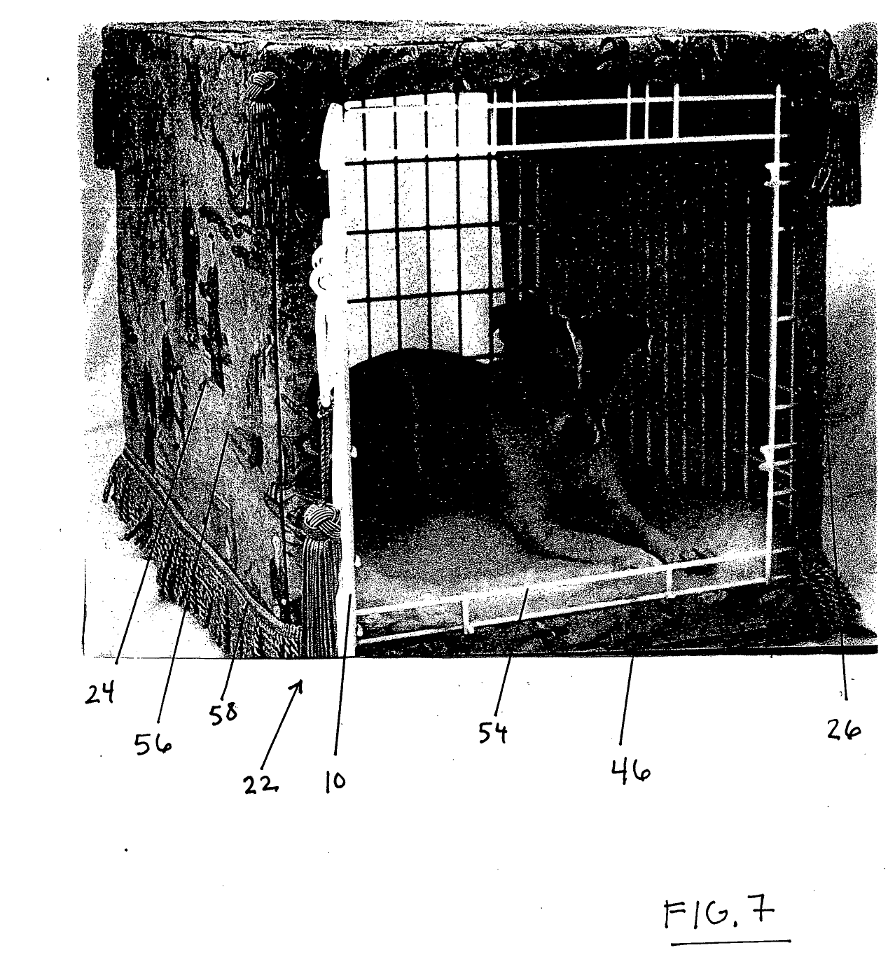

Referring to FIG. 7, there is shown the cover 22 of the pet containment system 10 with a dog therein. The connectors 44 shown in FIGS. 4 and 6 are under the pet containment system 10 to permit first side 24 and the second side 26 of the apparatus to be held taut against the pet containment system as shown. Preferably, the first connector 46 is on a front step facade or entry portion 54 of the pet containment system 10 to cover the facade. The fourth connector (not shown) likewise is on the rear facade of the pet containment system 10 to give the pet containment system a framed appearance. Preferably, the second connector 48 and the third connector 50 are between the first connector 46 and the fourth connector 48 and underneath the pet containment system 10 as shown in FIGS. 5 and 6.

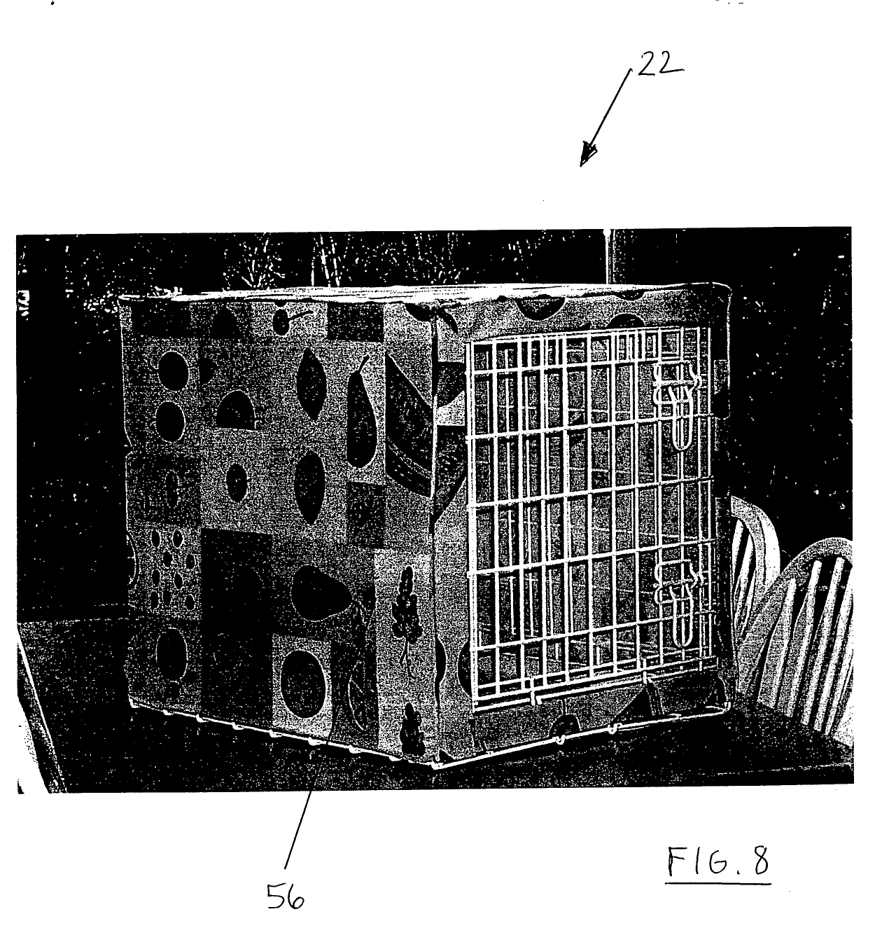

The cover 22 may have a pattern 56. The pattern 56 is on the exterior so that when the cover 22 is positioned on the pet containment system 10, the pattern is on the surface of the cover 10. The pattern 56 may be a multicolored floral pattern, a design, or any other aesthetically pleasing arrangement as shown in FIG. 8. The pattern 56 may be a solid color, a woven color, a number of various prints, a textured bonded leather, a customized pattern, a monogram, a name, a logo, a painting, a picture, a photo, an image, a digital image, a canvas painting, text, or any combinations thereof. The pattern 56 may be on only a portion of the cover 22 or alternatively the entire cover 22. The cover 22 may have a fringe 58 or a number of tassels on one or more edges of the cover for decorative purposes. The cover 10 may further be embellished with buttons, tassels, and fringes and be manufactured with a first and a second window (not shown) for limited visibility of the pet by the user.

It should be understood that the foregoing description is only illustrative of the present invention. Various alternatives and modifications can be devised by those skilled in the art without departing from the invention. Accordingly, the present invention is intended to embrace all such alternatives, modifications and variances.

What is claimed is:

1. A cover for a pet containment system with a first pet containment system side and a second pet containment system side, the cover comprising:
a body portion being formed of a first resilient material, said body portion having a first lateral side with a first edge and a second lateral side with a second edge, said second lateral side being opposite said first lateral side; and
a plurality of members for connecting said first lateral side to said second lateral side, said plurality of members being positionable underneath the pet containment system, wherein said plurality of members secure the cover on the pet containment system, and wherein said first lateral side is held against the first pet containment system side and said second lateral side is held against the second pet containment system side to bias tautly the cover to the pet containment system to act to prevent access therebetween.

2. The cover of claim 1, wherein said first resilient material is selected from the group consisting of may be a cotton material, a cotton weave material, a polyester, a bonded leather, canvas, velvet, an acrylic, a nylon, a micro-fiber material, a fleece material, a wicker material, a mesh fabric, a seagras fabric, a subrella® fabric material, a coolaroo® fabric material, leather, a velour, a silk, a nylon, a cotton, an elastomer, a weather proof material, a foam rubber, a polyvinyl chloride, a closed cell resistant foam plastic material, a polypropylene, a polyurethane, a polyethylene, a composite material, and any combinations thereof.

3. The cover of claim 1, wherein said plurality of members have at least one member being elastic and at least one member being inelastic.

4. The cover of claim 1, wherein said plurality of members connect a first edge of said first lateral side to a second edge of said second lateral side.

5. The cover of claim 1, further comprising a first opening to permit ingress and egress to and from the pet containment system.

6. The cover of claim 5, further comprising a second opening to permit ingress and egress to and from the pet containment system.

7. The cover of claim 1, further comprising a plurality of openings in a location of the cover, said location being selected from the group consisting of said first lateral side, said second lateral side, a front, a rear, and any combinations thereof.

8. The cover of claim 7, further comprising a fringe.

9. The cover of claim 1, wherein said first resilient material prevents light from entering the cover.

10. The cover of claim 1, wherein said first resilient material prevents water from entering the cover.

11. The cover of claim 1, wherein said first resilient material prevents wind from entering the cover.

12. The cover of claim 1, wherein said plurality of members are each generally orthogonal.

13. The cover of claim 1, wherein said plurality of members each have a thickness, said thickness being suitable to be in a location under the cover without disturbing a balance of the pet containment system on a structure.

14. The cover of claim 1, further comprising a tassel, said tassel for framing an entrance of the cover.

15. The cover of claim 1, wherein said first lateral side and second lateral side each have an exterior surface, said exterior surface having a pattern.

16. A cover for converting a pet containment system with a first pet containment system side and a second pet containment system side into a den for an animal, the cover comprising:
a body portion being formed of a first resilient material, said body portion having a first lateral side with a first edge and a second lateral side with a second edge, said second lateral side being opposite said first lateral side;
a first member;
a second elastic member;
a third elastic member; and
a fourth member, said first through fourth members for connecting said first lateral side to said second lateral side, wherein said first through fourth members secure the cover on the pet containment system, and wherein said first lateral side is held against the first pet containment system side and said second lateral side is held against the second pet containment system side to bias tautly the cover to the pet containment system to prevent access therebetween.

17. The cover of claim 16, wherein said second elastic member and said third elastic member are arranged between said first member and said fourth member.

18. The cover of claim 16, wherein said first member and said fourth member are each made from said first resilient material.

19. The cover of claim 16, wherein said first lateral side and said second lateral side each has an exterior surface with a pattern that is aesthetically pleasing.

20. The cover of claim 19, wherein said exterior surface insulates the pet containment system.

21. The cover of claim 19, wherein said pattern is on a location of said exterior surface, said location being selected from the group consisting of said first lateral side, said second lateral side, and any combinations thereof.

22. A cover in combination with a portable pet containment system, the portable pet containment system having a first pet containment system side and a second pet containment system side, the cover comprising:
a body portion being formed of a first resilient material, said first resilient material being deformable and lightweight to permit folding of said first resilient material, said body portion having a first lateral side with a first edge and a second lateral side with a second edge, said second lateral side being opposite said first lateral side;
a first member being formed from said first resilient material;
a second elastic member;
a third elastic member; and
a fourth member being formed from said first resilient material, said first through fourth members connecting said first lateral side with said second lateral side, wherein said first through fourth members secure the cover on the portable pet containment system, and wherein said first lateral side is held substantially taut against the first pet containment system side and said second lateral side is held substantially taut against the second pet containment system side to minimize the possibility that the cover will be disturbed when positioned on the portable pet containment system.

23. The cover of claim 22, further comprising a window for viewing the pet in the portable pet containment system.
